(19) United States
(12) Patent Application Publication
(10) Pub. No.: US 2017/0303521 A1
(43) Pub. Date: Oct. 26, 2017

(54) Fishing Rod Line Threading Device

(71) Applicants: Jay Arbetter, Dallas, TX (US); Jeffrey D. Sarembock, Dallas, TX (US)

(72) Inventors: Jay Arbetter, Dallas, TX (US); Jeffrey D. Sarembock, Dallas, TX (US)

(21) Appl. No.: 15/134,075

(22) Filed: Apr. 20, 2016

(51) Int. Cl. A01K 91/03

(52) U.S. Cl. CPC A01K 91/03

(57) ABSTRACT

The fishing rod line threading device includes an elongate shaft with a diameter suitable for passing through the rod guides on a fishing pole, and a gripping member on one end for gripping a fishing line to retain the line while passing through the rod guides. The gripping member includes a space within which the fishing line is retained while the device is passed through the rod guides. Slight pressure is required to release the retained line from the space. Alternate embodiments of the gripping member are disclosed. One or more feed ramps may guide the line into the space, or the line may be inserted into the space and retained by a positionable sleeve.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to fishing accessories and, more specifically, to an accessory for threading leader and line through fishing rod guides.

### Description of Related Art Including Information Disclosed Under 37 CFR 1.97 and 1.98

Light-weight fishing line, or line and leader used for fly fishing, is limp and difficult to manage when preparing a pole for use. For example, a light-weight line of approximately 2 to 4 pounds has no stiffness and is difficult to feed through the pole eyes (or rod guides), especially when standing in or near the body of water in which one intends to fish. Moreover, when hiking to and from the body of water it is necessary to breakdown the pole, which eventually necessitates re-feeding the line through the pole eyes each time it is to be used.

Currently there are no reasonable accessory devices for use to thread the line or leader through the pole eyes, which typically range from approximately 3 mm to 12 mm in diameter. Without an accessory device the fisherman must physically extend the leader/line from the reel several feet, and thread the limp line by hand through each rod guide all the while supporting the pole and other gear that might be worn on the person. This is a difficult task that often results in dropped and lost gear or losing control of the limp line such that it falls back through the pole eyes so that the process must begin anew. Moreover, this light-weight line is difficult to see in the sun, making it even more likely that it will be inadvertently dropped during the process of feeding it through the pole guides. Once dropped, gravity and wind cause the line to fall from the threaded pole guides once again requiring that the process begin anew.

Use of a sewing needle to thread the line is highly impractical because of the possibility of a needlestick injury to the fisherman and/or puncture of and damage to gear. Moreover, to use a sewing needle would require threading the eye of the needle first, and tying the line to the needle using both hands. This is highly impractical and difficult to accomplish successfully, especially in a stream or lake woodlands setting.

What is needed is a fishing accessory device that can accept and grip a light weight leader/line for easy threading of the line through the pole eyes, all using a single hand. Also, this fishing accessory device should be compact for easy storage and use, and sufficiently blunt to prevent punctures. The present invention satisfies these needs and others as will be understood following a thorough reading of the invention description provided herein.

### BRIEF SUMMARY OF THE INVENTION

The present invention is drawn to an embodiment of a fishing rod line threading device for single-handedly threading a fishing line or leader through the rod guides of a fishing rod, the device comprising: an elongate shaft having a diameter capable of passing through the rod guides of a fishing rod, the shaft having a proximal end and a distal end, the proximal end including a gripping member for releasably retaining a fishing line, the gripping member comprising a space for receiving the fishing line. Additional embodiments include a gripping member further comprising one or more of: a feed ramp for guiding the fishing line into the gripping member; a feed ramp for guiding the fishing line into a kerf having a space of sufficient length and width to releasably retain the fishing line therein; a feed ramp for guiding the fishing line into the space, the feed ramp comprising a pair of abutting members forming a slit opening through which the fishing line may pass into the space; a feed ramp for guiding the fishing line into the space, the feed ramp comprising a pair of abutting members forming a slit opening through which the fishing line may pass into the space, the pair of abutting members each forming a crotch within the space for releasably retaining the fishing line therein; a feed ramp for guiding the fishing line into the space, the feed ramp comprising a ramp face and an overhang feature forming a slit opening through which the fishing line may pass into the space; a feed ramp for guiding the fishing line into the space, the feed ramp comprising a ramp face and an overhang feature forming a slit opening through which the fishing line may pass into the space, the feed ramp forming a crotch within the space for releasably retaining the fishing line therein; a sleeve member slidably retained on the elongate shaft between a distal end cap and a proximal shoulder, the sleeve member positionable along the elongate shaft in at least a first position to uncover the space and a second position to cover the space; and an end cap slidably retained on the elongate shaft and positionable along the elongate shaft in at least a first position to uncover the space and a second position to cover the space. In yet another embodiment the elongate shaft has at least one substantially flat side.

The present invention is also drawing to an embodiment of a method for single-handedly threading a fishing line or leader through the rod guides of a fishing rod, the method steps comprising: providing a fishing rod and corresponding fishing line; providing a fishing line threading device comprising an elongate shaft having a diameter capable of passing through the rod guides of a fishing rod, the shaft having a proximal end and a distal end, the proximal end including a gripping member for releasably retaining a fishing line, the gripping member comprising a space for receiving the fishing line; gripping the elongate shaft with a thumb and an opposing finger while gripping the fishing line with at least one other curled finger; pulling the gripped fishing line taut while sliding the taught fishing line into the space for receiving the fishing line, the fishing line gripped therein; and feeding the threading device and fishing line gripped therein through the fishing rod guides. Other embodiments include method steps further comprising: sliding fishing line along a feed ramp and into the gripping member; sliding fishing line along a feed ramp and into a kerf within the gripping member; or sliding fishing line along a feed ramp and into the space through a slit formed by a pair of abutting members. Another embodiment includes the method steps further comprising: sliding fishing line along a feed ramp and into the space through a slit formed by a pair of abutting members, wherein the abutting members each form a crotch within the space for releasably retaining the fishing line therein; and sliding the fishing line into a crotch to be gripped therein. In yet another embodiment the method steps further comprise: sliding fishing line along a feed ramp and into the space through a slit formed by the ramp face and an overhang feature. Another embodiment includes method steps further comprising: sliding fishing line along a feed ramp and into the space through a slit formed by the ramp face and an overhang feature, wherein the feed ramp forms a crotch within the space for releasably retaining the fishing line therein; and sliding the fishing line into a crotch to be gripped therein. Another embodiment includes method steps further comprising: moving a sliding member to a first position to uncover the space; inserting the end of the fishing line into the space and holding the line therein; and moving the sliding member to a second position to cover the space and trap the fishing line within the space. Still, another embodiment includes method steps further comprising: removing the fishing line from the gripping member.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 depicts a first embodiment of a fishing rod line threading device in accordance with the invention disclosed herein;

FIG. 2 depicts a second embodiment of a fishing rod line threading device in accordance with the invention disclosed herein;

FIG. 3A depicts a frontal view of a third embodiment of a fishing rod line threading device in accordance with the invention disclosed herein;

FIG. 3B depicts the same view rotated 90 degrees to display the arrangement of the component parts and void space therein;

FIG. 4 depicts a fourth embodiment of a fishing rod line threading device in accordance with the invention disclosed herein;

FIG. 5 depicts a standard fishing rod before line setup using one of the device embodiments;

FIG. 6 depicts attachment of the first device embodiment to the line to begin the setup process;

FIG. 7 depicts attachment of the second device embodiment to the line to begin the setup process;

FIG. 8 depicts attachment of the third device embodiment to the line to begin the setup process;

FIG. 9 depicts attachment of the fourth device embodiment to the line to begin the setup process;

FIG. 10 depicts the fourth device embodiment line attachment in greater detail; and

FIG. 11 depicts use of the embodiment to complete the fishing rod line setup process.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

The term “fishing line” as used herein is a fishing line or leader attached to the end of a fishing line. The present invention is effective for any weight of fishing line, but is especially effective for use with light-weight fishing line or leader, which is difficult to see, has little stiffness, and is exceedingly difficult to feed through the rod guides of a fishing rod when preparing the rod while standing within or on the bank of a stream or other body of water. This is especially evident when attempting to do the feeding with one hand while holding the rod with the other.

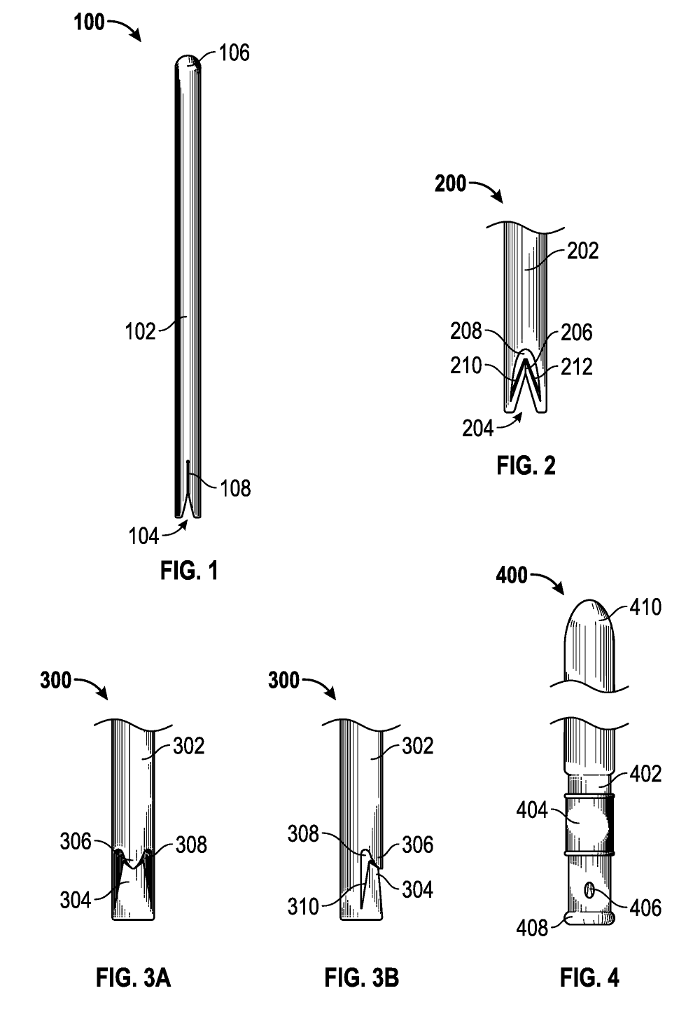

FIG. 1 depicts a first embodiment of a fishing rod line threading device in accordance with the invention disclosed herein. As depicted, the device (100) includes an elongate shaft (102) having a proximal and a distal end. The proximal end features a fishing line gripping member while the distal end features a substantially rounded tip (106). The distal end tip (106) is preferably substantially rounded to prevent puncturing bags, clothing, or skin. However, a pointed or even substantially flattened tip may also be utilized depending on the application, and are within the scope of the appended claims.

The proximal end gripping member features a V-shaped cutout forming a pair of feed ramps (104) as shown. At the apex of the feed ramps (104) is a thin kerf (108) forming a grip means for gripping a fishing line. The width of the kerf (108) is slightly less than the fishing line diameter to ensure sufficient gripping strength on a line inserted therein. One of ordinary skill is capable of selection of the kerf width in relation to the fishing line thickness for which the device is intended to be used. The Kerf (108) depth as measured along the elongate shaft (102) in the axial direction is greater than the line thickness, and in the present embodiment is approximately 4 to 8 times the line thickness. Other embodiments may be more or less in depth, depending on material utilized for the elongate shaft (102) and application requirements, the choice of which is within the skill of one of ordinary skill.

The device (100) in the present embodiment is constructed from molded or extruded polymer material. The feed ramps (104) and kerf (108) may be formed during the molding process or may be otherwise machined as a final step. Other embodiments may utilize wood or metal depending on design parameters, for example, projected end cost, environmental exposure requirements, weight limitations, etc. Selection of material type and manufacturing technique is within the skill of one of ordinary skill in the art.

The elongate shaft (102) of the present embodiment is cylindrical in form for ease in penetrating the rod guides. The shaft (102) diameter is less than the smallest rod guide through which the device is intended to pass. For example, a rod having a tip guide of 3 mm in diameter would allow passage of a device having a shaft (102) of approximately 2.5 mm in diameter. Other embodiments may have cross sectional forms that are other than cylindrical. For example, one or more flat sides may be formed along the shaft to prevent rolling if the device is placed on a flat surface. More complex forms, for example, a star-shaped cross section, are also possible. Such other shaft forms are envisioned herein and are within the scope of the appended claims.

FIG. 2 depicts a second embodiment of a fishing rod line threading device in accordance with the invention disclosed herein. This device (200) embodiment utilizes the elongate shaft (202) as described above, but differs with regard to the proximal gripping member. This gripping member features a pair of abutting members (210 and 212) that form fee ramps (204) that serve to direct a fishing line into the gripping member. A slit opening (206) in the abutting members (210 and 212) acts as a gate that allows passage of the fishing line into a space (208) for receiving the fishing line. The abutting members (210 and 212) form a crotch within the space (208) near the bottom that forms a grip means for gripping the line. The inner surface of the abutting members (210 and 212), which is the surface within the space (208) is beveled to increase the gripping force on an inserted fishing line. However, in another embodiment this inner surface might be substantially smooth, relying on the crotch “V” shape to grip the fishing line and releasably retain same while the device is pulled.

FIG. 3A depicts a frontal view of a third embodiment of a fishing rod line threading device in accordance with the invention disclosed herein. This device (300) embodiment utilizes the elongate shaft (302) as described above, but differs with regard to the proximal gripping member. The device (300) depiction in this figure is split into two views, with FIG. 3A showing a frontal view of the gripping member and FIG. 3B showing a side view of the gripping member as if the device were rotated 90 degrees.

As shown, a feed ramp (304) is formed on the outer surface of the elongate shaft (302) with a slit opening formed with an overhang feature (306). This slit opening acts as a gate that allows passage of a fishing line into the gripping member space (308). Within the space is a crotch feature (310) that is formed by the inner surface of the feed ramp (304) member, which is the inner surface of this feature located within the space (308). The crotch (310) forms a grip means for gripping the line. The inner surface of the feed ramp (304) is beveled to increase the gripping force on an inserted line. However, in another embodiment the inner surface might be substantially smooth, relying on the crotch “V” shape to grip the fishing line and releasably retain same while the device is pulled.

FIG. 4 depicts a fourth embodiment of a fishing rod line threading device in accordance with the invention disclosed herein. This device (400) embodiment utilizes the elongate shaft (402) as described above, but differs with regard to the proximal gripping member. This gripping member features a sleeve member (404) that is slidably retained on the shaft (402) by a shoulder feature (408) that is molded into the shaft and an end cap (410) that is fitted over the distal end of the shaft (402). The end cap (410) is press-fit and/or glued over the distal tip. In another embodiment the sleeve sliding member has no such retention features and is allowed to slide along the shaft (402).

The shaft (402) also includes a space for receiving the fishing line end. In the present embodiment the space (406) is a hole that is less than the diameter of the shaft (402), while in another embodiment the space (406) is a hole that passes through the diameter. The sleeve (404) may be placed in a first position that exposes the hole (406), and a second position that substantially covers the hole (406). A gap between the inner surface of the sleeve (404) and the outer surface of the shaft (402) along which the sleeve slides is adequate to trap a fishing line beneath the sleeve when the end of the line is placed within the space (406) and the sleeve (404) is moved to the second position. In this fashion the line is releasably retained while the device is pulled. The line may be released by sliding the sleeve (404) back to the first position.

In yet another embodiment the end cap (410) is neither press-fitted nor adhered to the shaft (402), but rather is capable of being slid over the shaft (402) and removed at will. In this embodiment the end cap (410) is approximately the same axial length as the shaft (402) to obviate the need for a separate sliding sleeve as in the previous embodiment. Instead, the end cap (410) of this embodiment extends to cover the space (406) for receiving the fishing line end once fully installed over the shaft (402), acting as the gripping member. In use, the end cap sliding member may be slid upward to a first position, away from the space (406) to expose the space (406) and to allow insertion of the fishing line end, and then slid downward to a second position, over the space (406) to trap the fishing line therein. The gap between the inner surface of the end cap (410) and outer surface of the shaft (402) along which the end cap slides is adequate to trap the fishing line therebetween.

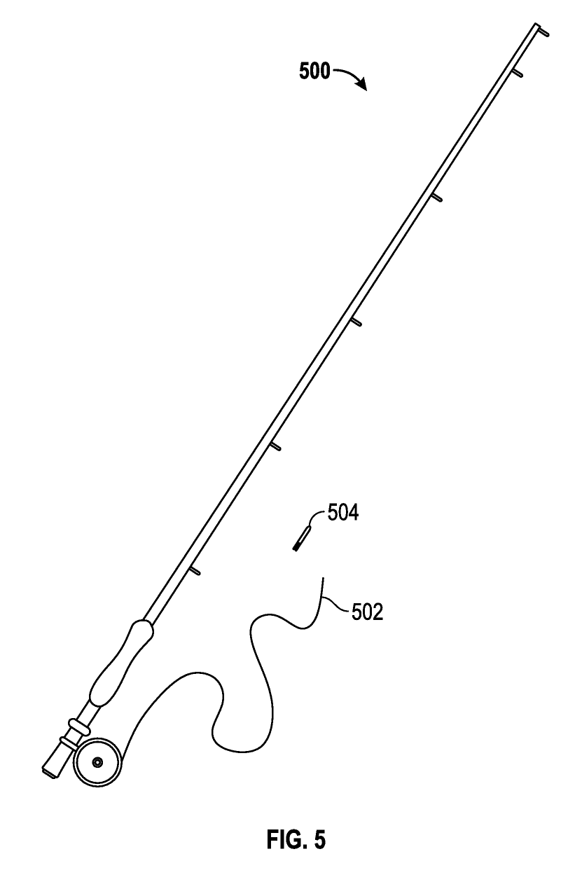

FIG. 5 depicts a standard fishing rod before line setup using one of the device embodiments. As shown is a fishing rod device (500) having a reel with spool of fishing line (502) for feeding through the rod guides. A fishing line threading device (504) as disclosed herein is provided to aid in threading the fishing line (502) through the guides, which is necessary to prepare the rod for fishing. Again, the fishing line threading device includes an elongate shaft having a diameter capable of passing through the rod guides of the fishing rod.

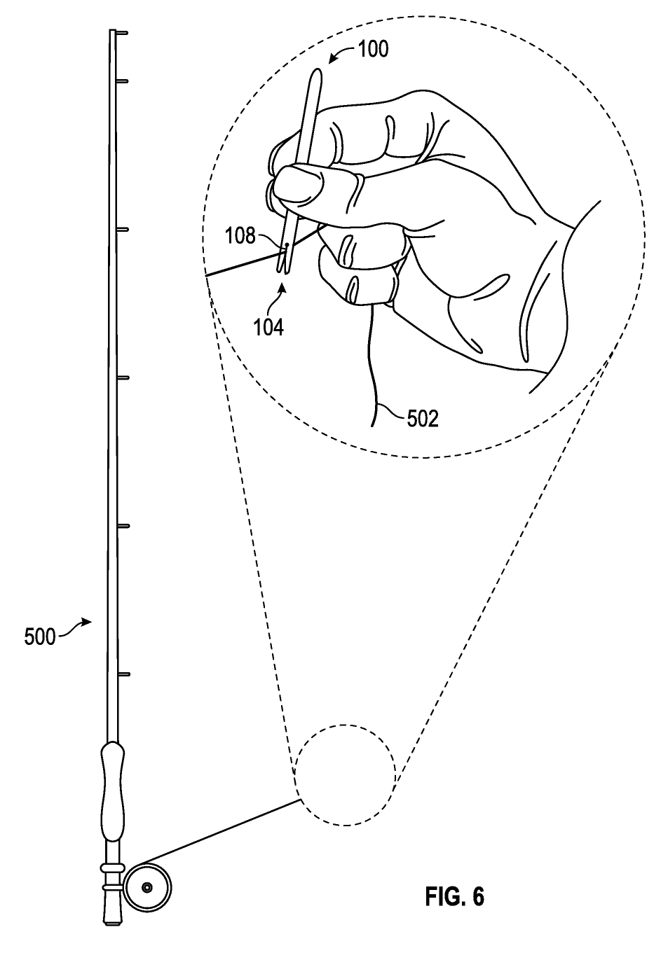

FIG. 6 depicts attachment of the first device embodiment to the line to begin the setup process. Using a device (100) as depicted herein, it is possible to hold the rod (500) with one hand while gripping the fishing line (502) with the curled little finger and ring finger of the other hand. While pulling the line taught, the line threading device (100) may be held as shown between the thumb and opposing fingers. The line threading device (100) feed ramps (104) may be placed over the line (502) and pushed downward to cause the line to pass into the kerf (108) where it is gripped.

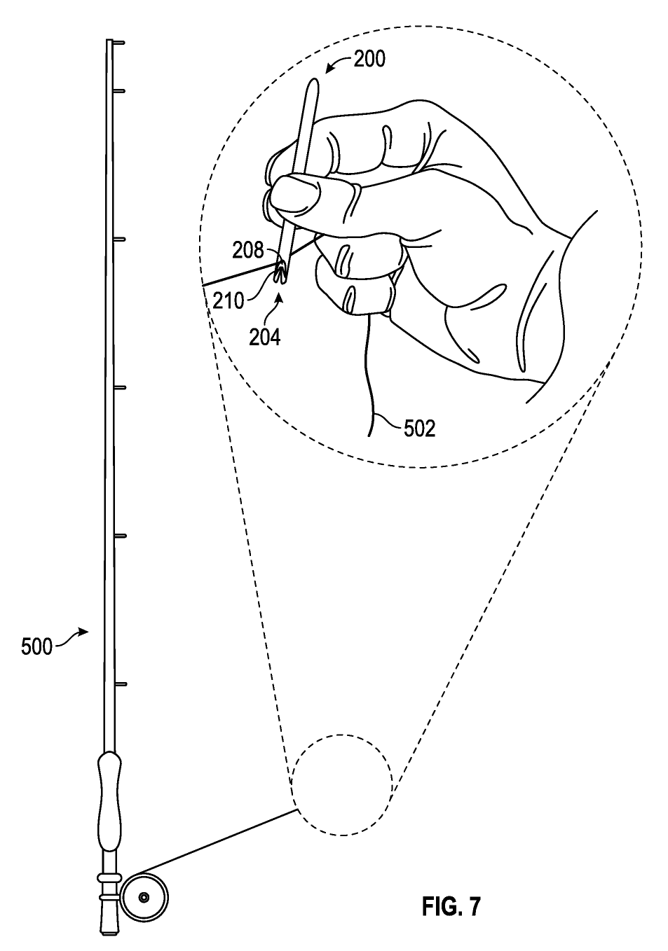

FIG. 7 depicts attachment of the second device embodiment to the line to begin the setup process. Utilizing the same steps as before to grip the line and device (200), the device (200) feed ramps (204) may be placed over the line (502) and pushed downward to cause the line to pass through the slit between the abutting members and into the space (208). A subsequent upward tug on the device (200) will set the line (502) within the crotch of an abutting member (210).

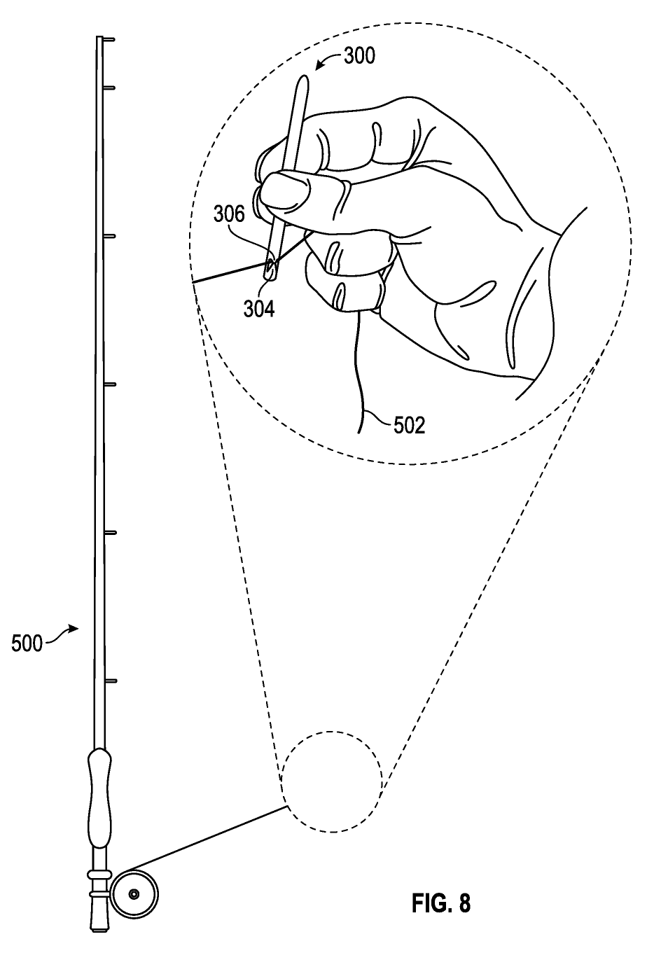

FIG. 8 depicts attachment of the third device embodiment to the line to begin the setup process. Utilizing the same steps as before to grip the line and device (300), the line may be placed against the feed ramp (304). Pushing downward on the device (300) causes the line to pass along the feed ramp (304) and through the slit between the feed ramp and overhang (306) and into the line receiving space (308). A subsequent upward tug on the device (300) will set the line (502) within the crotch formed by the feed ramp member (304) within the space (308).

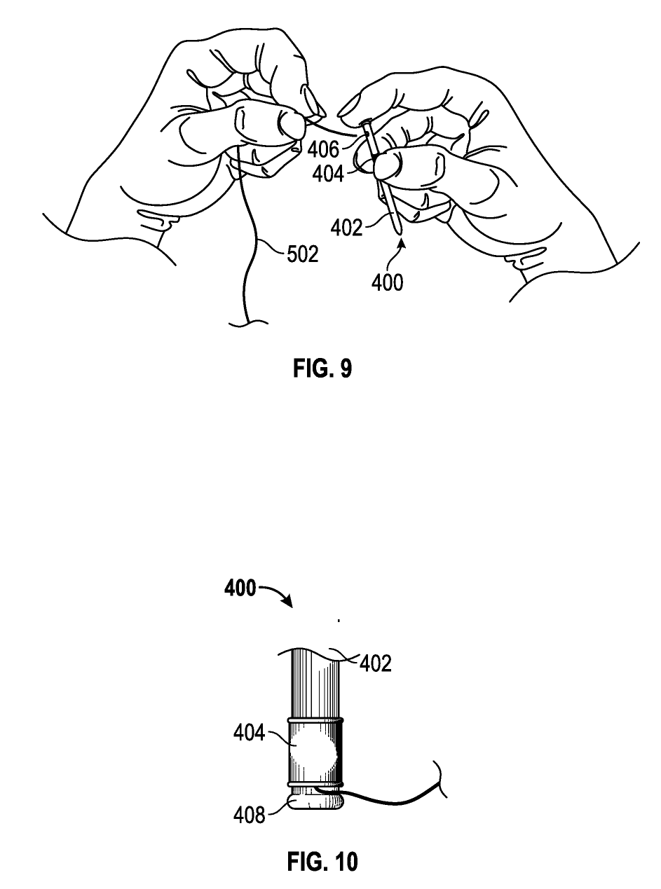

FIG. 9 depicts attachment of the fourth device embodiment to the line to begin the setup process. The device (400) may be held as shown with the sleeve in the first position, with the space (406) uncovered. The end of the fishing line (502) may be fed through the space (406) and held while the sleeve (404) is moved to the second position to cover the hole and grip the line as depicted in FIG. 10. To release the fishing line the sleeve (404) may be slid along the shaft (402) back to the first position.

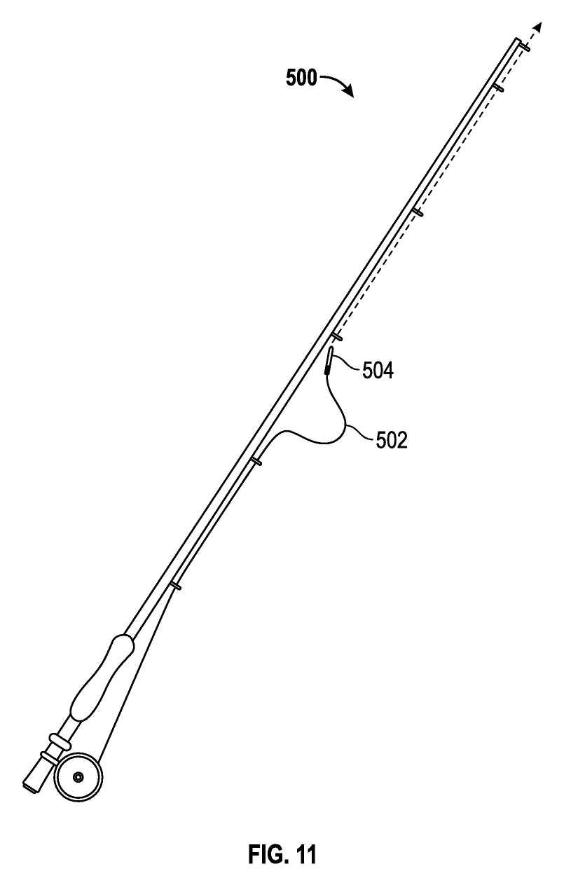

FIG. 11 depicts use of the embodiment to complete the fishing rod line setup process. Once the fishing line (502) is releasably attached to the threading device (504), the device is threaded through each rod guide to complete the rod (500) setup process. Threading may be accomplished with one hand while holding the rod (500) with the other. Release of the fishing line (502) from the threading device (504) is accomplished as described above.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

We claim:

1. A fishing rod line threading device for single-handedly threading a fishing line or leader through the rod guides of a fishing rod, the device comprising:
an elongate shaft having a diameter capable of passing through the rod guides of a fishing rod, the shaft having a proximal end and a distal end, the proximal end including a gripping member for releasably retaining a fishing line, the gripping member comprising a space for receiving the fishing line.

2. The device of claim 1, the gripping member further comprising:
a feed ramp for guiding the fishing line into the gripping member.

3. The device of claim 1, the gripping member further comprising:
a feed ramp for guiding the fishing line into a kerf having a space of sufficient length and width to releasably retain the fishing line therein.

4. The device of claim 1, the gripping member further comprising:
a feed ramp for guiding the fishing line into the space, the feed ramp comprising a pair of abutting members forming a slit opening through which the fishing line may pass into the space.

5. The device of claim 1, the gripping member further comprising:
a feed ramp for guiding the fishing line into the space, the feed ramp comprising a pair of abutting members forming a slit opening through which the fishing line may pass into the space, the pair of abutting members each forming a crotch within the space for releasably retaining the fishing line therein.

6. The device of claim 1, the gripping member further comprising:
a feed ramp for guiding the fishing line into the space, the feed ramp comprising a ramp face and an overhang feature forming a slit opening through which the fishing line may pass into the space.

7. The device of claim 1, the gripping member further comprising:
a feed ramp for guiding the fishing line into the space, the feed ramp comprising a ramp face and an overhang feature forming a slit opening through which the fishing line may pass into the space, the feed ramp forming a crotch within the space for releasably retaining the fishing line therein.

8. The device of claim 1, the gripping member further comprising:
a sleeve member slidably retained on the elongate shaft between a distal end cap and a proximal shoulder, the sleeve member positionable along the elongate shaft in at least a first position to uncover the space and a second position to cover the space.

9. The device of claim 1, the gripping member further comprising:
an end cap slidably retained on the elongate shaft and positionable along the elongate shaft in at least a first position to uncover the space and a second position to cover the space.

10. The device of claim 1, wherein the elongate shaft has at least one substantially flat side.

11. A method for single-handedly threading a fishing line or leader through the rod guides of a fishing rod, the method steps comprising:
providing a fishing rod and corresponding fishing line;
providing a fishing line threading device comprising an elongate shaft having a diameter capable of passing through the rod guides of a fishing rod, the shaft having a proximal end and a distal end, the proximal end including a gripping member for releasably retaining a fishing line, the gripping member comprising a space for receiving the fishing line;
gripping the elongate shaft with a thumb and an opposing finger while gripping the fishing line with at least one other curled finger;
pulling the gripped fishing line taut while sliding the taught fishing line into the space for receiving the fishing line, the fishing line gripped therein; and
feeding the threading device and fishing line gripped therein through the fishing rod guides.

12. The method of claim 11, the method steps further comprising:
sliding fishing line along a feed ramp and into the gripping member.

13. The method of claim 11, the method steps further comprising:
sliding fishing line along a feed ramp and into a kerf within the gripping member.

14. The method of claim 11, the method steps further comprising:
sliding fishing line along a feed ramp and into the space through a slit formed by a pair of abutting members.

15. The method of claim 11, the method steps further comprising:
sliding fishing line along a feed ramp and into the space through a slit formed by a pair of abutting members, wherein the abutting members each form a crotch within the space for releasably retaining the fishing line therein; and
sliding the fishing line into a crotch to be gripped therein.

16. The method of claim 11, the method steps further comprising:
sliding fishing line along a feed ramp and into the space through a slit formed by the ramp face and an overhang feature.

17. The method of claim 11, the method steps further comprising:
sliding fishing line along a feed ramp and into the space through a slit formed by the ramp face and an overhang feature, wherein the feed ramp forms a crotch within the space for releasably retaining the fishing line therein; and
sliding the fishing line into a crotch to be gripped therein.

18. The method of claim 11, the method steps further comprising:
moving a sliding member to a first position to uncover the space;
inserting the end of the fishing line into the space and holding the line therein; and
moving the sliding member to a second position to cover the space and trap the fishing line within the space.

19. The method of claim 11, the method steps further comprising:
removing the fishing line from the gripping member.
